(19) United States
(12) Patent Application Publication
(10) Pub. No.: US 2008/0295136 A1
(43) Pub. Date: Nov. 27, 2008

(54) HIGH FREQUENCY RECEIVING APPARATUS

(76) Inventor: Kensaku SHIMAZAKI, Osaka (JP)

Correspondence Address: BIRCH STEWART KOLASCH & BIRCH, PO BOX 747, FALLS CHURCH, VA, 22040-0747, US

(21) Appl. No.: 12/125,345

(22) Filed: May 22, 2008

(30) Foreign Application Priority Data
May 24, 2007 (JP) 2007-138257(P)

(51) Int. Cl. H04N 7/20

(52) U.S. Cl. 725/63

(57) ABSTRACT

In a high frequency receiver main body 40, on a circuit board 12 within a shield case 9 with a bottom, distributors 3a and 3b, and filter circuits 4a and 4b, AGC amplification circuits 5a and 5b, mixers 6a and 6b, local oscillation circuits 8a and 8b, and demodulation circuits 15a and 15b for processing RF signals are provided. The inside of the shield case 9 is partitioned by a partition member 41 into six regions, and sealed with a shield lid. Input connectors 1a and 1b are attached to a first side surface of the shield case 9. An output connector 7a outputting an RF signal distributed by the distributor 3a is attached to a second side surface thereof. An output connector 7b outputting an RF signal distributed by the distributor 3b is attached to a third side surface thereof.

This nonprovisional application is based on Japanese Patent Application No. 2007-138257 filed with the Japan Patent Office on May 24, 2007, the entire contents of which are hereby incorporated by reference.

### BACKGROUND OF THE INVENTION

1. Field of the Invention

The present invention relates to a high frequency receiving apparatus, and in particular to a hybrid high frequency receiving apparatus capable of receiving both terrestrial broadcast waves and satellite broadcast waves.

2. Description of the Background Art

A high frequency receiving apparatus is used to receive terrestrial broadcast and satellite broadcast. As an example of such a high frequency receiving apparatus, a tuner will be described. As shown in FIG. 7, in a conventional tuner 130, a motherboard 119 is placed within a cabinet 120, and a high frequency receiver main body 140, a terrestrial broadcast distributor unit 113, a satellite broadcast distributor unit 114, a microcomputer 116, a signal processing circuit 117, a power supply circuit 118, and the like are mounted on motherboard 119 at respective predetermined positions.

As shown in FIG. 8, in high frequency receiver main body 140, a shield case 109 is provided therein with filter circuits 104a and 104b, AGC (Automatic Gain Control) amplification circuits 105a and 105b, mixers 106a and 106b, local oscillation circuits 108a and 108b, and demodulation circuits 115a and 115b identified as circuit blocks, and seated with a shield lid 110 (see FIG. 7). These filter circuits 104a and 104b and the like are provided in two sets, for an RF (Radio Frequency) signal for terrestrial broadcast and an RF signal for satellite broadcast.

The inside of shield case 109 is partitioned by a partition member 141, corresponding to the circuit blocks, Filter circuits 104a and 104b and the like are placed in predetermined regions partitioned by partition member 141.

Next, a function of tuner 130 will be described. Firstly, an RF signal for terrestrial broadcast and an RF signal for satellite broadcast output from terrestrial broadcast distributor unit 113 and satellite broadcast distributor unit 114 are input to input connectors 101a and 101b, respectively. The RF signal for terrestrial broadcast input to input connector 101a is processed in each of the circuit blocks including AGC amplification circuit 105a, filter circuit 104a, mixer 106a, local oscillation circuit 108a, and demodulation circuit 115a.

The RF signal for satellite broadcast input to input connector 101b is also processed in each of the circuit blocks including AGC amplification circuit 105b, filter circuit 104b, mixer 106b, local oscillation circuit 108b, and demodulation circuit 115b. The respective processed RF signals are output to signal processing circuit 117 as demodulation signals.

On this occasion, a harmonic wave of the RF signal for terrestrial broadcast may overlap and interference with each of the RF signal and a local oscillation signal for satellite broadcast. Further, a harmonic wave of a local oscillation signal for terrestrial broadcast may overlap and interference with each of the RF signal and the local oscillation signal for satellite broadcast. Therefore, to prevent such interference, the signals are electrically isolated by partitioning the inside of shield case 109 with partition member 141, corresponding to the circuit blocks. Tuner 130 is disclosed for example in Japanese Registered Utility Model No. 3096172.

However, a tuner as a conventional high frequency receiving apparatus has a problem described below. Recently, thinner and smaller-sized television receivers, DVD (Digital Versatile Disc) recorders, or the like are in demand, and price reduction is also being pursued. Accordingly, to respond to these demands, a thinner or smaller-sized tuner is also in demand.

As shown in FIG. 7, tuner 130 described above includes high frequency receiver main bodies 140 each receiving and processing the two RF signals for terrestrial broadcast and satellite broadcast, and accordingly two sets of RF distributor units 113 and 114 are required. Therefore, a space for placing two high frequency receiver main bodies 140 and two RF distributor units 113 and 114, that is, a total of four units, should be secured within cabinet 120 of tuner 130, which has been one of the factors inhibiting size reduction and the like. Further, an operation for mounting these units on motherboard 119 is also required, which has been one of the factors raising the cost and inhibiting price reduction.

### SUMMARY OF THE INVENTION

The present invention has been made to solve the aforementioned problems, and one object of the invention is to provide a high frequency receiving apparatus that is reduced in size and contributes to price reduction.

A high frequency receiving apparatus in accordance with the present invention is a high frequency receiving apparatus receiving terrestrial broadcast and satellite broadcast, including a predetermined casing, a first distributor, a second distributor, a first circuit portion, a second circuit portion, a first output terminal, and a second output terminal. The first distributor is provided within the casing for distributing an input first signal for terrestrial broadcast. The second distributor is provided within the casing for distributing an input second signal for satellite broadcast. The first circuit portion is provided within the casing for processing the first signal distributed by the first distributor and outputting the first signal as a demodulation signal. The second circuit portion is provided within the casing for processing the second signal distributed by the second distributor and outputting the second signal as a demodulation signal. The first output terminal is placed on the casing for outputting the first signal distributed by the first distributor. The second output terminal is placed on the casing for outputting the second signal distributed by the second distributor.

With this configuration, in addition to the first circuit portion processing the first signal for terrestrial broadcast and the second circuit portion processing the second signal for satellite broadcast, the first distributor distributing the first signal and the second distributor distributing the second signal are provided within the casing serving as a high frequency receiver main body. Thereby, the first distributor and the second distributor are accommodated within the high frequency receiver main body, and thus saving in space and reduction in the number of man-hours for mounting can be achieved, when compared to a case where the first distributor and the second distributor are provided separately from the casing. As a result, the high frequency receiving apparatus can be reduced in size, and can contribute to price reduction.

More specifically, preferably, the high frequency receiving apparatus includes a board on which the first distributor, the second distributor, the first circuit portion, and the second circuit portion are mounted, and the casing includes a shield case with a bottom accommodating the board, and a shield lid closing the shield case.

As to the positions of the first output terminal and the second output terminal, they are preferably placed on side surface portions of the shield case. They may also be placed on the shield lid.

As the first output terminal and the second output terminal, a predetermined jack is preferable. Preferably, such a jack is placed within the shield case, and the shield lid is provided with an insertion hole for a predetermined plug to be connected to the jack.

As the jack and the plug, an F-type jack and an F-type plug, an RCA pin jack and an RCA pin plug, or an SMB jack and an SMB plug can be employed.

Preferably, the high frequency receiving apparatus includes a guide portion provided around the insertion hole for guiding the plug to the jack, for easy connection of the plug to the jack.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a partial perspective view showing an inside of a tuner in accordance with an embodiment of the present invention.

FIG. 2 is a plan view showing a circuit configuration inside a high frequency receiver main body in the embodiment.

FIG. 3 is a perspective view showing the high frequency receiver main body in the embodiment.

FIG. 4 is a partial perspective view showing an F-type jack and an F-type plug as an output connector in the embodiment.

FIG. 5 is a partial perspective view showing an RCA pin jack and an RCA pin plug as an output connector in the embodiment.

FIG. 6 is a partial perspective view showing an SMB jack and an SMB plug as an output connector in the embodiment.

FIG. 7 is a partial perspective view showing an inside of a conventional tuner.

FIG. 8 is a plan view showing a circuit configuration inside a high frequency receiver main body in the conventional tuner.

### DESCRIPTION OF THE PREFERRED EMBODIMENTS

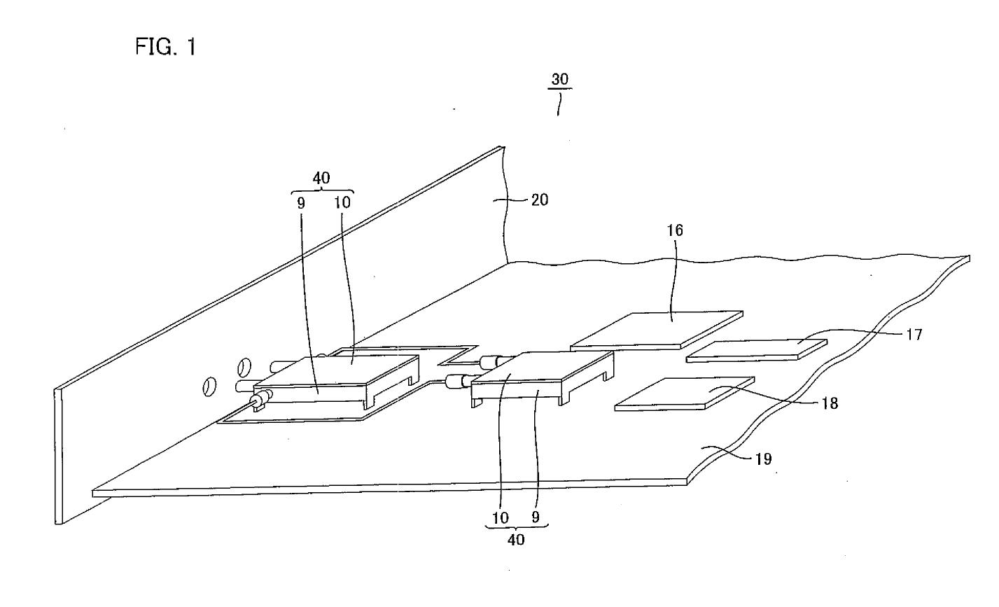

A tuner as an example of a high frequency receiving apparatus in accordance with an embodiment of the present invention will be described. As shown in FIG. 1, in a tuner 30, a motherboard 19 is placed within a cabinet 20, and a high frequency receiver main body 40 is mounted on motherboard 19. Other than high frequency receiver main body 40, a microcomputer 16, a signal processing circuit 17, a power supply circuit 18, and the like are mounted on motherboard 19 at respective predetermined positions.

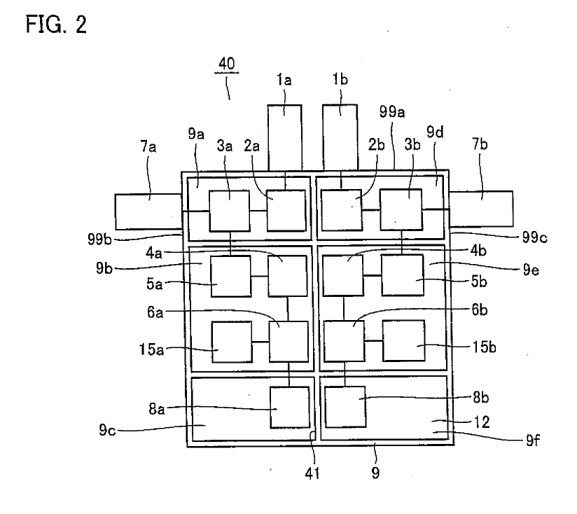

As shown in FIG. 2, in high frequency receiver main body 40, on a circuit board 12 within a shield case 9 with a bottom, a first-stage amplifier 2a, a distributor 3a, a filter circuit 4a, an AGC amplification circuit 5a, a mixer 6a, a local oscillation circuit 8a, and a demodulation circuit 15a are provided as circuit blocks for terrestrial broadcast. Similarly, a first-stage amplifier 2b, a distributor 3b, a filter circuit 4b, an AGC amplification circuit 5b, a mixer 6b, a local oscillation circuit 8b, and a demodulation circuit 15b are provided as circuit blocks for satellite broadcast.

The inside of shield case 9 is partitioned by a partition member 41 into six regions, corresponding to the circuit blocks. For terrestrial broadcast, first-stage amplifier 2a and distributor 3a are provided in a first region 9a, filter circuit 4a, AGC amplification circuits 5a, mixer 6a, and demodulation circuit 15a are provided in a second region 9b, and local oscillation circuit 8a is provided in a third region 9c. For satellite broadcast, first-stage amplifier 2b and distributor 3b are provided in a fourth region 9d, filter circuit 4b, AGC amplification circuits 5b, mixer 6b, and demodulation circuit 15b are provided in a fifth region 9e, and local oscillation circuit 8b is provided in a sixth region 9f.

As shown in FIG. 1, the inside of shield case 9 with a bottom accommodating the circuit blocks is sealed with a shield lid 10. An input connector 1a receiving an RE signal for terrestrial broadcast and an input connector 1b receiving an RF signal for satellite broadcast are attached to a first side surface 99a of shield case 9 with a bottom. An output connector 7a outputting an RF signal for terrestrial broadcast distributed by distributor 3a is attached to a second side surface 99b of shield case 9. Further, an output connector 7b outputting an RF signal for satellite broadcast distributed by distributor 3b is attached to a third side surface 99c of shield case 9.

Next, a function of tuner 30 will be described. Firstly, the RF signal for terrestrial broadcast input from input connector 1a is amplified in first-stage amplifier 2a and input to distributor 3a. The power of the RF signal input to distributor 3a is distributed into the power of an RF signal to be transmitted to AGC amplification circuit 5a and the like and the power of an RF signal to be output to the outside of high frequency receiver main body 40. The RF signal to be output to the outside of high frequency receiver main body 40 is output to the outside via output connector 7a. On the other hand, the RF signal transmitted to AGC amplification circuit 5a is processed in filter circuit 4a, mixer 6a, demodulation circuit 15a, and local oscillation circuit 8a. The processed signal is output to signal processing circuit 17 as a demodulation signal.

Next, the RF signal for satellite broadcast input from input connector 1b is also amplified in first-stage amplifier 2b and input to distributor 3b, as with the RF signal for terrestrial broadcast. The power of the RF signal input to distributor 3b is distributed into the power of an RF signal to be transmitted to AGC amplification circuit 5b and the like and the power of an RF signal to be output to the outside of high frequency receiver main body 40. The RF signal to be output to the outside of high frequency receiver main body 40 is output to the outside via output connector 7b. On the other hand, the RF signal transmitted to AGC amplification circuit 5b is processed in filter circuit 4b, mixer 6b, demodulation circuit 15b, and local oscillation circuit 8b. The processed signal is output to signal processing circuit 17 as a demodulation signal.

In tuner 30 described above, distributors 3a and 3b distributing and outputting the RF signals are provided within shield case 9 of high frequency receiver main body 40, together with the predetermined circuits processing the RF signal for terrestrial broadcast or satellite broadcast. Thereby, distributors 3a and 3b are integrated into high frequency receiver main body 40, and thus saving in space and reduction in the number of man-hours for mounting can be achieved, when compared to a conventional case where a distributor is separated from a high frequency receiver main body. As a result, tuner 30 as a high frequency receiving apparatus can be reduced in size, and can contribute to price reduction.

Since first-stage amplifiers 2a and 2b provided in high frequency receiver main body 40 of tuner 30 are of a low noise type to improve an NF (Noise Figure) of tuner 30, a harmonic wave is generated as a distortion component when the RF signals input from input connectors 1a and 1b are too strong. Further, local oscillation circuits 8a and 8b generate not only local oscillation signals but also harmonic waves of the local oscillation signals.

Even when a harmonic wave is likely to be generated as described above, interference between the RF signal for terrestrial broadcast and the RE signal for satellite broadcast can be suppressed reliably by separating the circuit blocks processing the RF signal for terrestrial broadcast from the circuit blocks processing the RF signal for satellite broadcast using partition member 41.

First Modification

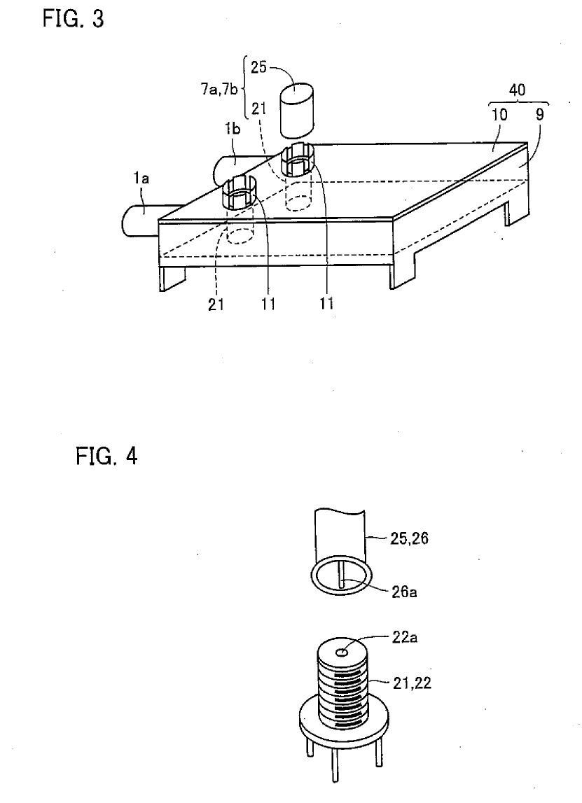

For high frequency receiver main body 40 of tuner 30 described above, the description has been given of an exemplary case where output connector 7a outputting the distributed RF signal for terrestrial broadcast and output connector 7b outputting the distributed RF signal for satellite broadcast are attached to the second side surface 99b and the third side surface 99c of shield case 9 facing each other, respectively. In addition, as shown in FIG. 3, output connectors 7a and 7b may be attached to shield lid 10, for example. Also in this case, interference between the RF signal for terrestrial broadcast and the RF signal for satellite broadcast can be suppressed.

Second Modification

It is desirable to employ a jack 21 and a plug 25 as output connector 7a or 7b (see FIG. 3). As an example of such a jack and a plug, as shown in FIG. 4, an F-type jack 22 and an F-type plug 26 excellent in high frequency characteristic may be employed, for example. In this case, a center contact 26a of F-type plug 26 is connected to a center contact 22a of F-type jack 22.

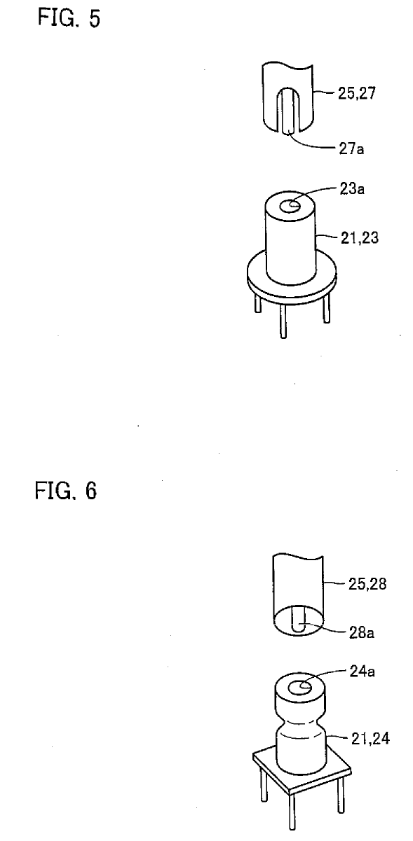

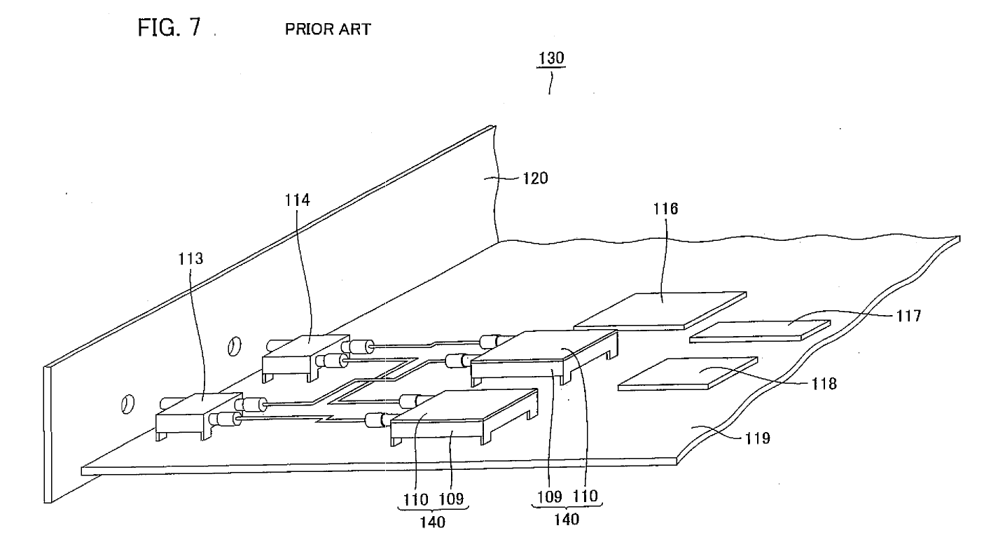

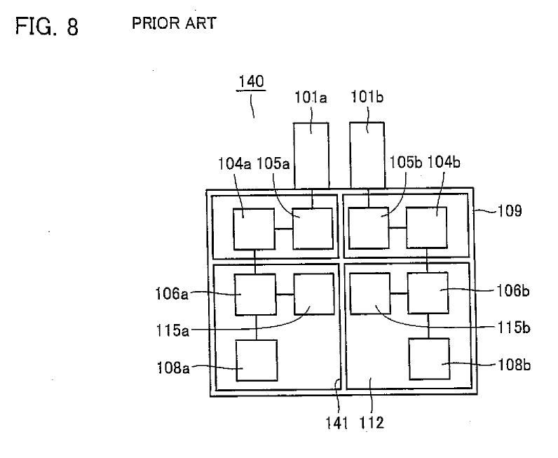

Further, as shown in FIG. 5, an RCA (Radio Cooperation of America) pin jack 23 and an RCA pin plug 27 widely used in terrestrial broadcast equipment may be employed, for example. In this case, a center contact 27a of RCA pin plug 27 is connected to a center contact 23a of RCA pin jack 23.

Furthermore, as shown in FIG. 6, an SMB (Sub Miniature Type B) jack 24 and an SMB plug 28 used in GHz band communication equipment may be employed, for example. In this case, a center contact 28a of SMB plug 28 is connected to a center contact 24a of SMB jack 24.

By employing a jack and a plug that are coaxial and have a high shielding property as described above, radiation of a signal from the inside of the high frequency receiver main body and incidence of an external signal can be suppressed. Further, as shown in FIG. 3, jack 21 may be provided within shield case 9, and a guide portion 11 formed by cutting and raising an opening portion may be provided on shield lid 10. Thereby, plug 25 can be easily inserted into jack 21.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A high frequency receiving apparatus receiving terrestrial broadcast and satellite broadcast, comprising:
a predetermined casing;
a first distributor provided within said casing for distributing an input first signal for terrestrial broadcast;
a second distributor provided within said casing for distributing an input second signal for satellite broadcast;
a predetermined first circuit portion provided within said casing for processing said first signal distributed by said first distributor and outputting said first signal as a demodulation signal;
a predetermined second circuit portion provided within said casing for processing said second signal distributed by said second distributor and outputting said second signal as a demodulation signal;
a first output terminal placed on said casing for outputting said first signal distributed by said first distributor; and
a second output terminal placed on said casing for outputting said second signal distributed by said second distributor.

2. The high frequency receiving apparatus according to claim 1, comprising a board on which said first distributor, said second distributor, said first circuit portion, and said second circuit portion are mounted,
wherein said casing includes
a shield case with a bottom accommodating said board, and
a shield lid closing said shield case.

3. The high frequency receiving apparatus according to claim 2, wherein said first output terminal and said second output terminal are placed on side surface portions of said shield case.

4. The high frequency receiving apparatus according to claim 2, wherein said first output terminal and said second output terminal are placed on said shield lid.

5. The high frequency receiving apparatus according to claim 4, wherein
said first output terminal and said second output terminal are predetermined jacks,
said predetermined jack is placed within said shield case, and
said shield lid is provided with an insertion hole for a predetermined plug to be connected to said jack.

6. The high frequency receiving apparatus according to claim 5, wherein
said predetermined jack is an F-type jack, and
said predetermined plug is an F-type plug.

7. The high frequency receiving apparatus according to claim 5, wherein
said predetermined jack is an RCA pin jack, and
said predetermined plug is an RCA pin plug.

8. The high frequency receiving apparatus according to claim 5, wherein
said predetermined jack is an SMB jack, and
said predetermined plug is an SMB plug.

9. The high frequency receiving apparatus according to claim 5, comprising a guide portion provided around said insertion hole for guiding said plug to said jack.
